(19) United States
(12) Patent Application Publication
(10) Pub. No.: US 2015/0167987 A1
(43) Pub. Date: Jun. 18, 2015

(54) COOKING APPLIANCE, CONTROLLER OF A COOKING APPLIANCE, AND ROUTER IN WIRED COMMUNICATION WITH A CONTROLLER OF A COOKING APPLIANCE

(71) Applicant: Electrolux Home Products, Inc., Charlotte, NC (US)

(72) Inventor: Albert Dale Peterson, White House, TN (US)

(73) Assignee: Electrolux Home Products, Inc., Charlotte, NC (US)

(21) Appl. No.: 14/108,499

(22) Filed: Dec. 17, 2013

(51) Int. Cl. F24C 3/12; G08C 19/00; G08C 17/02; F24C 7/08

(52) U.S. Cl. CPC F24C 3/12; F24C 7/08; G08C 19/00; G08C 17/02

(57) ABSTRACT

A cooking appliance may include one or more cooktop burners, a user interface configured to allow a user to input settings to control one or more of the cooktop burners, and a controller connected to the user interface, the controller being configured to allow control of the cooktop burners pursuant to the inputted settings, the controller being in wired communication with a router, the router being configured to communicate with the controller to allow a portable computer to remotely operate one or more of the cooktop burners, the router including a wireless data connection, a wired data connection, and a control circuit, the wireless data connection being established with the portable computer, the wired data connection being established with the controller.

### BACKGROUND

1. Field

The following description relates to a cooking appliance, a controller of a cooking appliance, and a router in wired communication with a controller of a cooking appliance.

2. Description of Related Art

Conventional cooking appliances may possess ways by which a user can be in control of the operation of the cooking appliance. For example, user control of a conventional cooking appliance may include the adjustment of knobs, the pressing of capacitive touch panels, or the browsing of an LED touch screen.

### SUMMARY

In one general aspect, a cooking appliance may include one or more cooktop burners, a user interface configured to allow a user to input settings to control one or more of the cooktop burners, and a controller connected to the user interface, the controller being configured to allow control of the cooktop burners pursuant to the inputted settings, the controller being in wired communication with a router, the router being configured to communicate with the controller to allow a portable computer to remotely operate one or more of the cooktop burners, the router including a wireless data connection, a wired data connection, and a control circuit, the wireless data connection being established with the portable computer, the wired data connection being established with the controller, the control circuit being configured to control the wireless and wired data connections and allow the portable computer to control the cooktop burners via the controller when the portable computer is within a predetermined distance of the control circuit. Once the portable computer has been in control of one or more of the cooktop burners and the portable computer subsequently leaves the predetermined distance during operation of the cooktop burners, the control circuit may instruct the controller to turn off the cooktop burners.

The router may be provided less than a distance from the cooktop burners from where the user operating the portable computer has a direct line of sight view of the cooktop burners being controlled.

A status of the cooktop burners may be provided by the controller to the portable computer via the control circuit once the portable computer requests to be allowed by the control circuit to control the cooktop burners via the controller and is within the predetermined distance of the control circuit.

The user interface may be configured to indicate when the portable computer is executing control over the cooktop burners.

Once the user interface is being used to control the cooktop burners and the portable computer is within the predetermined distance of the control circuit during operation of the cooktop burners, the controller may inhibit the portable computer from being used to control the cooktop burners and provide a status of the cooktop burners is provided to be displayed on the portable computer via the control circuit.

Once the portable computer is controlling the cooktop burners during operation of the cooktop burners, the controller may inhibit the user interface from being used to input settings for controlling the cooktop burners and provide a status of the cooktop burners to be displayed on the user interface.

In another general aspect, a controller of a cooking appliance may be provided. The controller may be configured to allow control of one or more cooktop burners of the cooking appliance pursuant to settings inputted by a user from a user interface of the cooking appliance that is connected to the controller. The controller may be in wired communication with a router. The router may be configured to communicate with the controller to allow a portable computer to remotely operate one or more of the cooktop burners. The router may include a wireless data connection, a wired data connection, and a control circuit. The wireless data connection may be established with the portable computer. The wired data connection may be established with the controller. The control circuit may be configured to control the wireless and wired data connections and allow the portable computer to control the cooktop burners via the controller once the portable computer is within a predetermined distance of the control circuit. Once the portable computer has been in control of one or more of the cooktop burners and the portable computer subsequently leaves the predetermined distance during operation of the cooktop burners, the control circuit may instruct the controller to turn off the cooktop burners.

In another general aspect, a router in wired communication with a controller of a cooking appliance may be provided. The controller may be configured to control one or more cooktop burners of the cooking appliance pursuant to commands of a user. The router may be configured to communicate with the controller to allow a portable computer to remotely operate one or more cooktop burners. The router may include a wireless data connection established with the portable computer, a wired data connection established with the controller, and a control circuit configured to control the wireless and wired data connections and allow the portable computer to control the cooktop burners via the controller once the portable computer is within a predetermined distance of the control circuit. Once the portable computer has been in control of one or more of the cooktop burners and the portable computer subsequently leaves the predetermined distance during operation of the cooktop burners, the control circuit may instruct the controller to turn off the cooktop burners.

The predetermined distance may be less than or equal to a range within which the wireless data connection can be established with the portable computer.

The router may be provided within a base station located less than a distance from the cooktop burners from where the user operating the portable computer has a direct line of sight view of the cooktop burners being controlled.

The base station may be configured to removably dock the portable computer thereto and inductively transfer power to the docked portable computer for powering and charging a battery of the docked portable computer.

The docking of the portable computer to the base station may define the predetermined distance. Once the docked portable computer has been in control of the cooktop burners during an operation session of the cooktop burners and the docked portable computer is subsequently undocked from the base station, the control circuit may instruct the controller to turn off the cooktop burners.

The router may further include a sensor configured to determine whether the portable computer is within the predetermined distance of the control circuit.

The router may be provided within a base station located less than a distance from the cooktop burners from where the user operating the portable computer has a direct line of sight view of the cooktop burners being controlled, the base station being configured to removably dock the portable computer thereto and inductively transfer power to the docked portable computer for powering and charging a battery of the docked portable computer. The router may further comprise a sensor configured to determine whether the portable computer is within the predetermined distance of the control circuit.

The docking of the portable computer to the base station may define the predetermined distance. Once the docked portable computer has been in control of the cooktop burners during an operation session of the cooktop burners and the sensor senses that the docked portable computer has become undocked from the base station, the control circuit may instruct the controller to turn off the cooktop burners.

A status of the cooktop burners may be provided by the controller to the portable computer via the control circuit once the portable computer requests to be allowed by the control circuit to control the cooktop burners via the controller and is within the predetermined distance of the control circuit.

Once the user interface is being used to control the cooktop burners and the portable computer is within the predetermined distance of the control circuit during operation of the cooktop burners, a status of the cooktop burners may be provided by the controller to the portable computer via the control circuit to enable the cooktop burners to be controlled by the portable computer when desired by the user.

Once the portable computer is controlling the cooktop burners during the operation of the cooktop burners, the controller may inhibit the user interface from being used by the user to input settings for controlling the cooktop burners and provide a status of the cooktop burners to the user interface to be displayed on the user interface.

Other features and aspects may be apparent from the following detailed description, the drawings, and the claims.

### BRIEF DESCRIPTION OF THE DRAWINGS

FIG. 1 is a perspective view illustrating an example of a router and a cooking appliance having gas cooktop burners according to an embodiment.

FIG. 2 is a perspective view illustrating an example of a router and a cooking appliance having electric cooktop burners according to an embodiment.

FIG. 3 is a side sectional view taken along line 3-3 in FIG. 2 illustrating an example of a cooking appliance according to an embodiment.

FIG. 4 is a rear view illustrating an example of a cooking appliance according to an embodiment.

FIG. 5 is a rear view of a cooking appliance illustrating an example of a router according to an embodiment.

FIG. 6 is a perspective view illustrating an example of a router and a tablet computer according to an embodiment.

FIG. 7 is a schematic view illustrating an example of a router according to an embodiment.

FIG. 8 is a schematic view illustrating an example of a router according to an embodiment.

FIG. 9 is a perspective view illustrating an example of a base station and a cooking appliance according to an embodiment.

FIG. 10 is a perspective view illustrating an example of a base station with a tablet computer being docked thereon and a cooking appliance according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Examples incorporating one or more embodiments are described and illustrated in the drawings. These illustrated examples are not intended to be limiting. For example, one or more aspects of an embodiment may be utilized in other embodiments and even other types of devices.

For purposes of embodiments described and illustrated herein, a “router” is defined as being any device serving to effectuate communication and data transfer between multiple devices. Multiple devices include, but are not limited to, a tablet computer, a desktop computer, a laptop computer, a mobile phone, a watch phone, an information aggregator, a controller, an electric circuit, or any type of device that can communicate in either a wired or wireless capacity with the router. These devices may be provided independently, but are not limited thereto and may be housed in any number of units, including, but not limited to, a cooking appliance, a food preservation appliance, a dish care appliance, a laundry care appliance, a floor care appliance, and any appliance in which some sort of control thereover is desired.

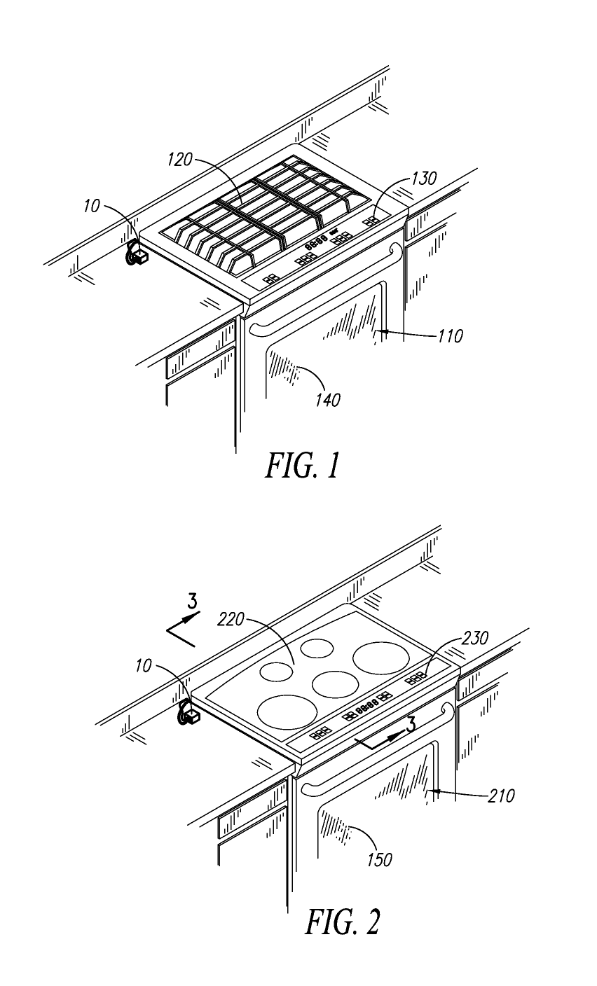

FIG. 1 is a perspective view illustrating an example of a router 10 and a cooking appliance 110 having gas cooktop burners 120 according to an embodiment. FIG. 2 is a perspective view illustrating an example of a router 10 and a cooking appliance 210 having electric cooktop burners 220 according to an embodiment. The cooktop burners 120 and 220 may be configured to heat items placed thereon for purposes of food preparation. The cooking appliances 110 and 120 may also include an oven 140 and an oven 150, respectively.

While built-in cooking appliances having singular ovens are illustrated as examples in FIGS. 1 and 2, embodiments disclosed herein are not limited thereto. For example, the cooking appliance may be a cooktop built into a cabinet and not having an oven controlled via a common user interface, i.e. separate appliances. The cooking appliance may include multiple ovens. The built-in cooktop may be either an electric cooktop or a gas cooktop. The cooking appliance may be a freestanding range-type cooking appliance with one or more ovens. The cooking appliance may be one that accepts dual types of fuel, such as natural gas for operation of cooktop burners and electric for operation of one or more ovens. Further, the cooking appliance may be an induction-type cooking appliance.

User interfaces 130 and 230 may be provided with each of the cooking appliances illustrated in FIGS. 1 and 2, respectively. User interfaces 130 and 230 may be configured to allow a user to input settings to control the cooktop burners 120 and 220, respectively. For example, the user interfaces 130 and 230 may be panel displays including touchpad controls to allow the user to manipulate the level at which the cooktop burners 120 and 230 respectively operate. The touchpad controls may be capacitive in nature. The panel displays may illustrate an operating status of the cooktop burners 120 and 220 to the user to enable the user to determine whether adjustments using the touchpad controls are necessary. Further, the panel display may operate similarly to a tablet computer, portable computer, or smart phone with applications available to the user for operation of all features of cooking appliances 110 and 210.

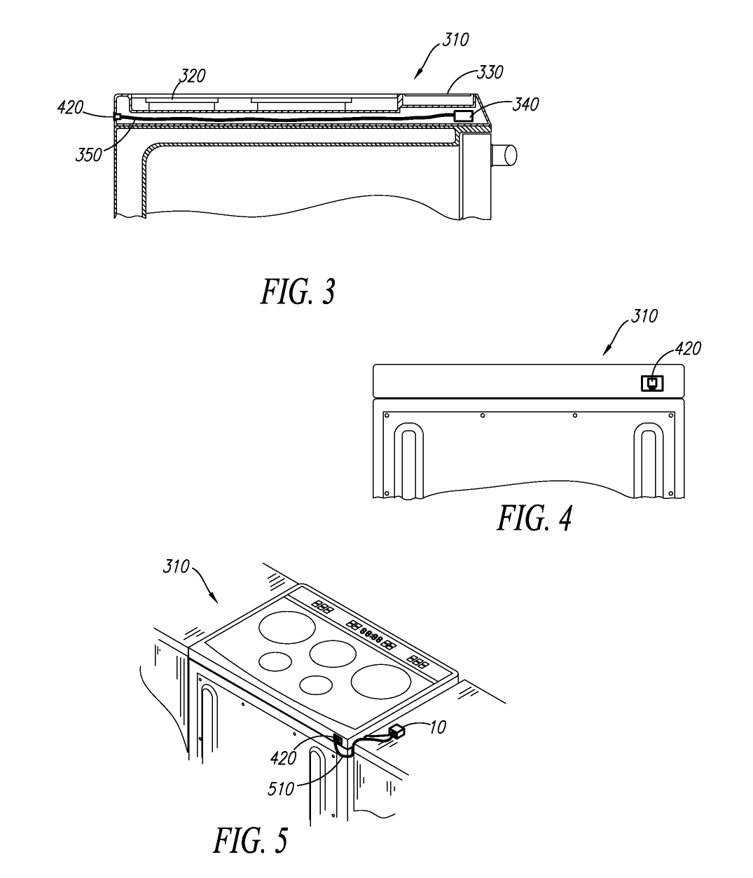

FIG. 3 is a side sectional view taken along line 3-3 in FIG. 2 illustrating an example of a cooking appliance 310 according to an embodiment. FIG. 4 is a rear view illustrating an example of a cooking 310 appliance according to an embodiment. The cooking appliance 310 may include cooktop burners 320, a user interface 330, a controller 340, and a communication wire 350. The user interface 330 may be connected to and operate the cooktop burners 320 through the controller 340. The controller 340 may be configured to allow control of the cooktop burners 320 pursuant to settings inputted by the user on the user interface 330. The controller 340 may have a plug receptacle (not shown) housed therein for connection of the communication wire 350 thereto. The communication wire 350 may run from the controller 340 to a back wall 360 of the cooking appliance 310, in which a plug receptacle 420 is provided for wired connection of the controller 340 to a device external to the cooking appliance 310.

While FIG. 3 illustrates the communication wire 350 extending from the controller 340 to a back wall 360 of the cooking appliance 310 along a certain path, embodiments disclosed herein are not limited thereto. For example, the communication wire 350 may extend from the controller 340 through side walls of the cooking appliance in which a plug receptacle may be provided for wired connection of the controller 340 to a device external to the cooking appliance 310. In addition, while FIG. 3 illustrates the controller 340 as being underneath a user interface 330, embodiments disclosed herein are not limited thereto. For example, a controller 340 may be provided at a rear portion of the cooking appliance 310, with a wire being run from the user interface 330 to the controller 340 to effect local control of the cooking appliance 310. Further, a user interface 330 and a controller 340 may be provided within a rear wall upward extension that extends upwardly from the cooktop burners 320 for user operation. In this case, the communication wire 350 may extend from the controller 340 a very short distance to a plug receptacle provided in the rear wall upward extension for connection of the controller 340 to a device external to the cooking appliance 310. Moreover, the user interface 330, the controller 340, the communication wire 350, and the plug receptacle 420 may be provided anywhere within the confines of the cooking appliance 310 as long as interaction between the controller 340 and the user interface 330 is permitted to take place through connections therebetween and the user interface 330 is easily accessible for a user to operate the cooking appliance 310 thereby.

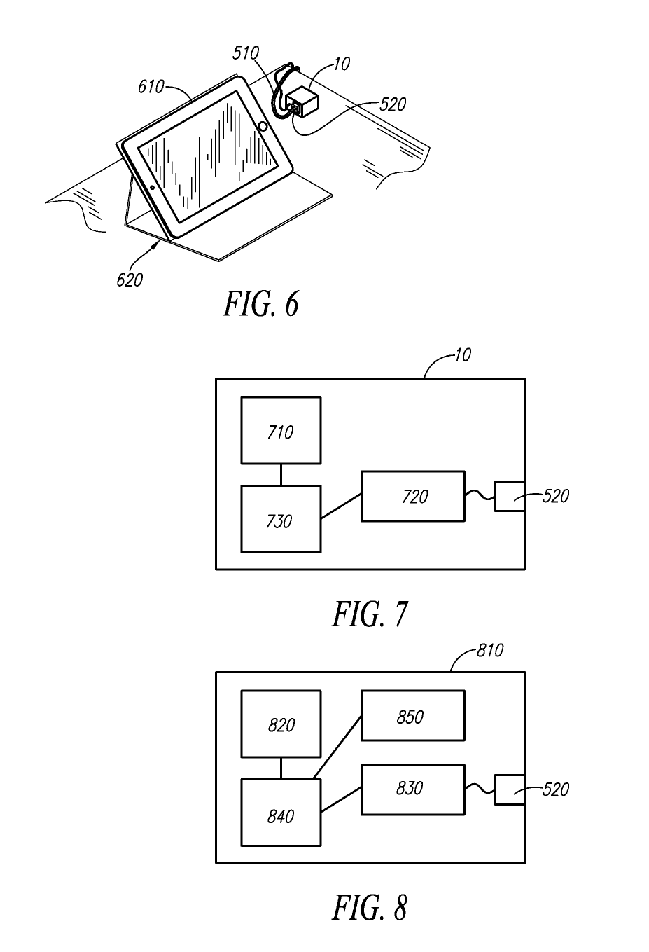

FIG. 5 is a rear view of cooking appliance 310 illustrating an example of a router 10 according to an embodiment. FIG. 6 is a perspective view illustrating an example of a router 10 and a tablet computer 610 according to an embodiment. FIG. 7 is a schematic view illustrating an example of a router 10 according to an embodiment. As is illustrated in FIG. 5, a communication wire 510 may connect the plug receptacle 420 of the cooking appliance 310 with a plug receptacle 520 provided on a rear portion of the router 10.

In order to comply with industry standards, the router 10 is provided less than a distance from the cooktop burners 320 from where a user operating a tablet computer 610 has a direct line of sight view of the cooktop burners 320 being controlled. However, the router 10 is not limited with respect to how close it can be to the cooking appliance as long as data can be transmitted optimally between the router 10 and the cooking appliance 310 and the router 10 and external equipment. While the router 10 is illustrated in various examples as resting on a shelf that resembles a kitchen countertop, the embodiments disclosed herein are not limited thereto. For example, the router 10 may be incorporated within or attached to the cooking appliance 310.

The router 10 may be configured to communicate with the controller 340 to allow a tablet computer 610 to remotely operate one or more of the cooktop burners 320 through the router 10. For example, the router 10 may receive communications from the tablet computer 610 directed to the controller 340 of the cooking appliance 310. The router 10 may route those communications to the controller 340 of the cooking appliance 310. Further, the router may receive communications from the controller 340 of the cooking appliance 310 directed to the tablet computer 610 regarding the status of the cooktop burners 320. The router 10 may receive these communications from the controller 340 and subsequently route the communications from the controller 340 to the tablet computer 610.

While, in multiple embodiments, one of the devices in communication with the router 10 may be a tablet computer 610, the embodiments described herein are not limited thereto. For example, devices that may be used to communicate with the controller 340 through the router 10 include, but are not limited to, a portable computer, which may include, but is not limited to, a tablet computer, a laptop computer, a mobile phone, or a watch phone, an information aggregator, a controller, an electric circuit, or any type of device that can communicate in either a wired or wireless capacity with the router 10.

In an embodiment, the router 10 may include a wireless data connection 710, a wired data connection 720, and a control circuit 730. The wireless data connection 710 may be an antenna, a transceiver, or any compatible device known to one of ordinary skill in the art. The wireless data connection 710 may be established between the router 10 and the tablet computer 610 or any device external to the cooking appliance 310 that is enabled to have the ability to communicate settings for the operation of the cooktop burners 320 through the router 10. The wired data connection 720 may be established between the router 10 and the controller 340 or any portable device of the cooking appliance 310 that is enabled to have control over the operation of the cooktop burners 320. The control circuit 730 may be configured to control the wireless and wired data connections 710, 720 and allow the tablet computer 610 to control the cooktop burners 320 via the controller 340 when the tablet computer 610 is within a predetermined distance of the control circuit 730.

In an example embodiment, the tablet computer 610 may need to be within the predetermined distance of the control circuit 730 to control the operation of the cooktop burners 320 via the controller 340. The predetermined distance of the control circuit 730 may be determined according to industry safety standards. For example, when the tablet computer 610 has been in control of one or more of the cooktop burners 320 and the tablet computer 610 subsequently leaves the predetermined distance during operation of the cooktop burners 320, the control circuit 730 may instruct the controller 340 to turn off the cooktop burners 320. Further, when the tablet computer 610 attempts to effectuate a connection through the router 10 with the controller 340 of the cooking appliance 310 and is out of the predetermined distance of the control circuit 730, the control circuit 730 may not allow the passage of the commands coming through the wireless data connection 710 from the tablet computer 610 to be communicated via the wired data connection 720 to the controller 340. In certain embodiments, such commands coming from the tablet computer 610 may not be received over the wireless data connection 710 because the tablet computer 610 may be out of a range in which communication between the tablet computer 610 and the router 10 over the wireless data connection 710 can be effectuated.

Further, in an embodiment, the predetermined distance may be established by being less than or equal to a range within which the wireless data connection 710 to the router 10 can be established with the tablet computer 610. For example, if the tablet computer 610 is operating the cooktop burners 320 and subsequently moves outside of the range in which the wireless data connection 710 can be made with the router 10, the control circuit may instruct the controller 340 to turn off the cooktop burners 320. In addition, during an operation of the cooktop burners 320 that has been controlled by the user interface 330 and the tablet computer 610 for a period through the operation, if the tablet computer 610 moves outside the predetermined distance, even if the user interface 330 is currently in control of the cooktop burners 320, the control circuit 730 may instruct the controller 340 to turn off the cooktop burners 320.

In an embodiment, when the tablet computer 610 is within the predetermined distance of the control circuit 730, a status of the cooktop burners 320 may be provided to the tablet computer 610 through the router 10 by the controller 340 via the control circuit 730 when the tablet computer 610 requests to be allowed by the control circuit 730 to control the cooktop burners 320 via the controller 340. In another embodiment, the user interface 330 may be configured to indicate to a user that the tablet computer 610 is executing control over the cooktop burners 320. During this period, the user interface 330 may be inhibited by the controller 340 from controlling the cooktop burners 320. However, the controller 340 may provide a status of the cooktop burners 320 for display on the user interface 330 during a period in which the cooktop burners 320 are being controlled by the tablet computer 610 via the controller 340.

In an additional embodiment, when the user interface 330 is being used to control the cooktop burners 320 via the controller 340 and the tablet computer 610 is within the predetermined distance of the control circuit 730 during operation of the cooktop burners 320, the controller 340 may instruct the control circuit 730 to inhibit the tablet computer 610 from connecting with the controller 340 to control the cooktop burners 320 until the user interface 330 has ended active control of the cooktop burners 320. In an another embodiment, when the tablet computer 610 is within the predetermined distance of the control circuit 730 during operation of the cooktop burners 320, although the tablet computer 610 may be inhibited by the control circuit 730 from connecting with the controller 340 to control the cooktop burners 320 until the user interface 330 has ended active control of the cooktop burners 320, the controller 340 may provide the control circuit 730 with the status of the cooktop burners 320 such that the status of the cooktop burners 320 can be communicated via the wireless data connection 710 to the tablet computer 610 and can be monitored until the user interface 330 has ended active control of the cooktop burners 320 and the tablet computer is permitted by the control circuit 730 and the controller 340 to control the cooktop burners 320.

FIG. 8 is a schematic view illustrating an example of a router 810 according to an embodiment. The router 810 may include a wireless data connection 820, a wired data connection 830, a control circuit 840, and a sensor 850. The wireless data connection 820, the wired data connection 830, and the control circuit 840 may operate in a way that is similar to the wireless data connection 710, the wired data connection 720, and the control circuit 830, respectively. However, in an embodiment, the sensor 850 may be employed to detect a position of the tablet computer 610 with respect to the router 810 to determine if the tablet computer 610 is disposed within the predetermined distance. For example, if the tablet computer 610 exits the predetermined distance within which operation of the cooktop burners 320 was allowed, the sensor may detect the exiting of the tablet computer 610 from the predetermined distance and communicate the detected exiting to the control circuit 840, which, in turn, may instruct the controller 340 to turn off the cooktop burners 320.

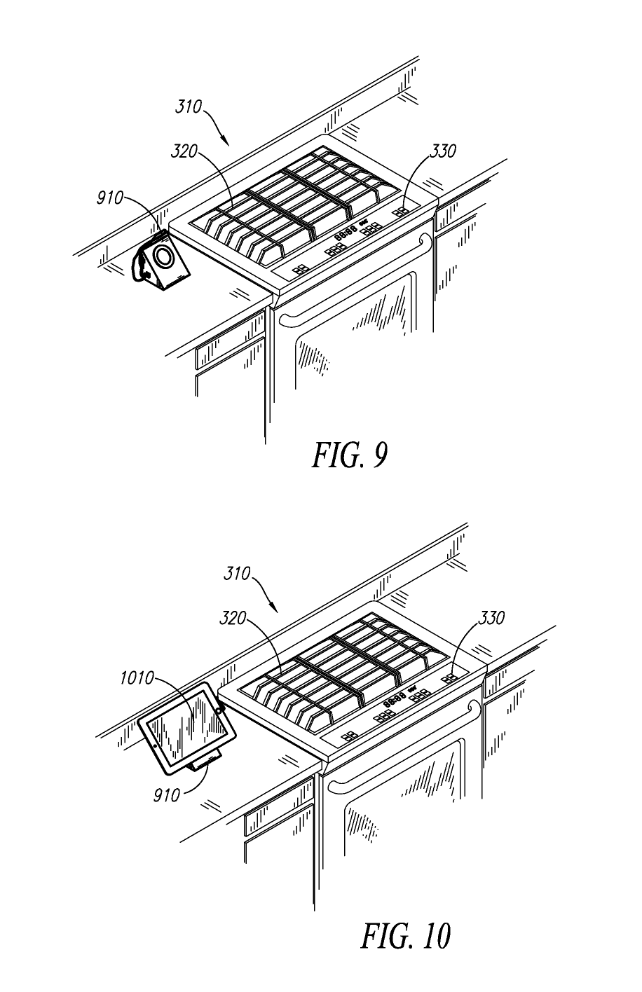

FIG. 9 is a perspective view illustrating an example of a base station 910 and a cooking appliance 310 according to an embodiment. FIG. 10 is a perspective view illustrating an example of a base station 910 with a tablet computer 1010 being docked thereon and a cooking appliance 310 according to an embodiment. In an embodiment, the router 10, 810 may be provided within a base station 910 located provided less than a distance from the cooktop burners 320 from where a user operating a tablet computer 1010 has a direct line of sight view of the cooktop burners 320 being controlled. The base station 910 may be configured to removably dock the tablet computer 1010 thereto and inductively transfer power to the docked tablet computer 1010 for powering and charging a battery (not shown) provided within the docked tablet computer 1010. In an embodiment, the docking of the tablet computer 1010 to the base station 910 may define the predetermined distance. In other words, when the tablet computer 1010 is docked to the base station 910, the tablet computer 1010 may be considered to be physically present within the predetermined distance. However, when the tablet computer 1010 is operating the cooktop burners 320 and has subsequently been undocked from the base station 910, the control circuit 730, 840 may instruct the controller 340 to turn off the cooktop burners 320. Indeed, the predetermined distance may be set to ensure that the only area in which the tablet computer 1010 can control or communicate with the cooktop burners 320 is when docked to the base station 910. The docking status of the tablet computer 1010 may be determined either by the range of the wireless data connection 710 of the router 10 or the sensor 850 provided in the router 810 or physical contact between the tablet computer 1010 and the base station 910. Either the range of the wireless data connection 710 of the router 10 or the sensor 850 provided in the router may be adjusted to limit the predetermined distance of the tablet computer 1010 to be when the tablet computer 1010 is docked to the base station 910.

While embodiments described above include the tablet computer 1010 required to be within a predetermined distance of the base station 910, embodiments described are not limited thereto. For example, an operation of the cooktop burners 320 could be terminated when the tablet computer 1010 is not physically connected to the base station 910.

While the tablet computer 1010 is illustrated as being docked to the base station 910 and charged by the base station 910, the embodiments described herein are not limited thereto. For example, an tablet computer 1010 may be mounted temporarily on a countertop with a foldable support 620 (shown in FIG. 6) while a wireless power source may be provided in close proximity to the tablet computer 1010, such as, but not limited to, on an underside of the countertop, at the rear of the countertop where the countertop meets a wall, or anywhere that the inductive or wireless transfer of power to the tablet computer 1010 for charging a battery of the tablet computer 1010 or powering the tablet computer 1010 during operation may be effectuated.

A number of examples have been described above. Nevertheless, it will be understood that various modifications may be made. For example, suitable results may be achieved if the described elements are combined in a different manner and/or replaced or supplemented by other elements or their equivalents. Accordingly, other implementations are within the scope of the following claims.

What is claimed is:

1. A cooking appliance, comprising:
one or more cooktop burners;
a user interface configured to allow a user to input settings to control one or more of the cooktop burners; and
a controller connected to the user interface, the controller being configured to allow control of the cooktop burners pursuant to the inputted settings, the controller being in wired communication with a router, the router being configured to communicate with the controller to allow a portable computer to remotely operate one or more of the cooktop burners, the router comprising a wireless data connection, a wired data connection, and a control circuit, the wireless data connection being established with the portable computer, the wired data connection being established with the controller, the control circuit being configured to control the wireless and wired data connections and allow the portable computer to control the cooktop burners via the controller when the portable computer is within a predetermined distance of the control circuit,
wherein, once the portable computer has been in control of one or more of the cooktop burners and the portable computer subsequently leaves the predetermined distance during operation of the cooktop burners, the control circuit instructs the controller to turn off the cooktop burners.

2. The cooking appliance of claim 1, wherein the router is provided less than a distance from the cooktop burners from where the user operating the portable computer has a direct line of sight view of the cooktop burners being controlled.

3. The cooking appliance of claim 1, wherein a status of the cooktop burners is provided by the controller to the portable computer via the control circuit once the portable computer requests to be allowed by the control circuit to control the cooktop burners via the controller and is within the predetermined distance of the control circuit.

4. The cooking appliance of claim 1, wherein the user interface is configured to indicate when the portable computer is executing control over the cooktop burners.

5. The cooking appliance of claim 1, wherein, once the user interface is being used to control the cooktop burners and the portable computer is within the predetermined distance of the control circuit during operation of the cooktop burners, the controller inhibits the portable computer from being used to control the cooktop burners and provides a status of the cooktop burners is provided to be displayed on the portable computer via the control circuit.

6. The cooking appliance of claim 1, wherein, once the portable computer is controlling the cooktop burners during operation of the cooktop burners, the controller inhibits the user interface from being used to input settings for controlling the cooktop burners and provides a status of the cooktop burners to be displayed on the user interface.

7. A controller of a cooking appliance, the controller being configured to allow control of one or more cooktop burners of the cooking appliance pursuant to settings inputted by a user from a user interface of the cooking appliance that is connected to the controller, the controller being in wired communication with a router, the router being configured to communicate with the controller to allow a portable computer to remotely operate one or more of the cooktop burners, the router comprising a wireless data connection, a wired data connection, and a control circuit, the wireless data connection being established with the portable computer, the wired data connection being established with the controller, the control circuit being configured to control the wireless and wired data connections and allow the portable computer to control the cooktop burners via the controller once the portable computer is within a predetermined distance of the control circuit,
wherein, once the portable computer has been in control of one or more of the cooktop burners and the portable computer subsequently leaves the predetermined distance during operation of the cooktop burners, the control circuit instructs the controller to turn off the cooktop burners.

8. The controller of claim 7, wherein the router is provided less than a distance from the cooktop burners from where the user operating the portable computer has a direct line of sight view of the cooktop burners being controlled.

9. The controller of claim 7, wherein a status of the cooktop burners is provided by the controller to the portable computer via the control circuit once the portable computer requests to be allowed by the control circuit to control the cooktop burners via the controller and is within the predetermined distance of the control circuit.

10. The controller of claim 7, wherein the user interface is configured to indicate when the portable computer is executing control over the cooktop burners.

11. The controller of claim 7, wherein, once the user interface is being used to control the cooktop burners and the portable computer is within the predetermined distance of the control circuit during operation of the cooktop burners, the controller inhibits the portable computer from being used to control the cooktop burners and provides a status of the cooktop burners is provided to be displayed on the portable computer via the control circuit.

12. The controller of claim 7, wherein, once the portable computer is controlling the cooktop burners during operation of the cooktop burners, the controller inhibits the user interface from being used to input settings for controlling the cooktop burners and provides a status of the cooktop burners to be displayed on the user interface.

13. A router in wired communication with a controller of a cooking appliance, the controller being configured to control one or more cooktop burners of the cooking appliance pursuant to commands of a user, the router being configured to communicate with the controller to allow a portable computer to remotely operate one or more cooktop burners, the router comprising:
a wireless data connection established with the portable computer;
a wired data connection established with the controller; and
a control circuit configured to control the wireless and wired data connections and allow the portable computer to control the cooktop burners via the controller once the portable computer is within a predetermined distance of the control circuit,
wherein, once the portable computer has been in control of one or more of the cooktop burners and the portable computer subsequently leaves the predetermined distance during operation of the cooktop burners, the control circuit instructs the controller to turn off the cooktop burners.

14. The router of claim 13, wherein the router is provided less than a distance from the cooktop burners from where the user operating the portable computer has a direct line of sight view of the cooktop burners being controlled.

15. The router of claim 13, wherein the predetermined distance is less than or equal to a range within which the wireless data connection can be established with the portable computer.

16. The router of claim 13, wherein the router is provided within a base station located less than a distance from the cooktop burners from where the user operating the portable computer has a direct line of sight view of the cooktop burners being controlled.

17. The router of claim 16, wherein the base station is configured to removably dock the portable computer thereto and inductively transfer power to the docked portable computer for powering and charging a battery of the docked portable computer.

18. The router of claim 17, wherein the docking of the portable computer to the base station defines the predetermined distance, and
wherein, once the docked portable computer has been in control of the cooktop burners during an operation session of the cooktop burners and the docked portable computer is subsequently undocked from the base station, the control circuit instructs the controller to turn off the cooktop burners.

19. The router of claim 13, wherein the router further comprises a sensor configured to determine whether the portable computer is within the predetermined distance of the control circuit.

20. The router of claim 13, wherein the router is provided within a base station located less than a distance from the cooktop burners from where the user operating the portable computer has a direct line of sight view of the cooktop burners being controlled, the base station being configured to removably dock the portable computer thereto and inductively transfer power to the docked portable computer for powering and charging a battery of the docked portable computer, and
wherein the router further comprises a sensor configured to determine whether the portable computer is within the predetermined distance of the control circuit.

21. The router of claim 20, wherein the docking of the portable computer to the base station defines the predetermined distance, and
wherein, once the docked portable computer has been in control of the cooktop burners during an operation session of the cooktop burners and the sensor senses that the docked portable computer has become undocked from the base station, the control circuit instructs the controller to turn off the cooktop burners.

22. The router of claim 13, wherein a status of the cooktop burners is provided by the controller to the portable computer via the control circuit once the portable computer requests to be allowed by the control circuit to control the cooktop burners via the controller and is within the predetermined distance of the control circuit.

23. The router of claim 13, wherein, once the user interface is being used to control the cooktop burners and the portable computer is within the predetermined distance of the control circuit during operation of the cooktop burners, a status of the cooktop burners is provided by the controller to the portable computer via the control circuit to enable the cooktop burners to be controlled by the portable computer when desired by the user.

24. The router of claim 13, wherein, once the portable computer is controlling the cooktop burners during the operation of the cooktop burners, the controller inhibits the user interface from being used by the user to input settings for controlling the cooktop burners and provides a status of the cooktop burners to the user interface to be displayed on the user interface.
